(19) United States
(12) Patent Application Publication
(10) Pub. No.: US 2015/0147006 A1
(43) Pub. Date: May 28, 2015

(54) TOTE FOR SLOW COOKERS AND THE LIKE

(71) Applicant: Nancie R. Beatty, LaRue, OH (US)

(72) Inventor: Nancie R. Beatty, LaRue, OH (US)

(21) Appl. No.: 14/087,695

(22) Filed: Nov. 22, 2013

(51) Int. Cl. A45C 7/00; A47J 36/00

(52) U.S. Cl. CPC A45C 7/0063; A47J 36/00
USPC 383/6

(57) ABSTRACT

A tote that is carried by a user and self-accommodates any container selected from different sized containers. The tote includes a bottom, a pair of side walls, and a pair of straps. The pair of side walls extend upwardly from the bottom, and are so disposed so as to allow the tote to self-accommodate the any container selected from the different sized containers. The pair of straps extend upwardly from the pair of side walls, respectively, and allow the tote to be carried by the user.

### BACKGROUND OF THE INVENTION

1. Field of the Invention:

The present invention relates to a tote, and more particularly, a tote for slow cookers and the like.

2. Description of the Prior Art:

Numerous innovations for container holders have been provided in the prior art that will be described. Even though these innovations may be suitable for the specific individual purposes to which they address, however, they differ from the present invention.

A FIRST EXAMPLE, U.S. Patent Office Document No. 3,262,283, Issued on Jul. 26, 1966, to Taylor teaches a jacket applicable about a carton of articles for retarding heat transfer between the articles and the atmosphere. The jacket includes a relatively hollow body having a relatively thin flat wall apparatus of a size to snugly fit about a carton to which it is applied. The relatively thin flat wall apparatus corresponds in size and shape to the interior walls of the carton. The relatively thin flat wall apparatus is equipped with portions connected at their extremities to provide a substantially contiguous enclosure for the sides of the carton to retain the later therein. The relatively thin flat wall apparatus is hollow, and contains a temperature modification medium of a character to retard heat transfer for an extended time to produce a prolonged temperature effect. The jacket is foldable and stackable, and within the wall apparatus is gelatin, whereby it is useable and discardable.

A SECOND EXAMPLE, U.S. Patent Office Document No. 3,507,312, Published/Issued on Apr. 21, 1970, to Peterson teaches a cover and holder constructed of fabric material in the shape and configuration of a container for receiving a dish or pan therein. The peripheral rim of the fabric holder is provided with an elastic band retaining the holder on the dish or pan, and flexible straps are connected to the peripheral rim of the holder to provide a carrying handle for the holder and dish or pan associated therewith.

A THIRD EXAMPLE, U.S. Patent Office Document No. 7,153,025, Issued on Dec. 26, 2006, to Jackson, et al. teaches a carrying case for heated food containers, particularly slow cookers, which has a flexible bottom wall, a side wall, and a lid so it can be adjusted to accommodate food containers of various different dimensions. A clamp assembly is provided for securely holding a lid on the food container within the carrying case to thereby minimize the likelihood of accidentally spilling its contents. Apparatus is provided for carrying other items on the lid of the carrying case. The case has a belt that is tightenable to adjust the case to different sizes of containers, and straps forming a handle.

A FOURTH EXAMPLE, U.S. Patent Office Document No. 20020114539, Published on Aug. 22, 2002, to Strevey, et al. teaches a foldable bag including a flexible laminate panel section, and a plurality of custom arranged or rearrangeable interior pockets. The bag is foldable to assume a folded closed configuration, an unfolded flat configuration, or a folded open configuration. In the folded open configuration, the bag is adapted to be supported by a support structure, as a chair back, in a configuration in which a plurality of interior pockets are in a substantially upright orientation and readily accessible. At least one pivotable pocket suitable for use as a work surface is includeable, together with at least one open configuration retaining unit. Also taught are methods of making the foldable bag.

A FIFTH EXAMPLE, U.S. Patent Office Document No. 20120255658, Published on Oct. 11, 2012, to Andreasson, et al. teaches a modular bag system has components for constructing a carrying bag of a variable and customized shape. The bag includes a main body, and side gusset panels. The main body has edges provided with zippers, respectively. Two lateral edges are approximated to form a tube. At least part of the outer edge of each side gusset panel has a zipper for joining to the ends of the tube. The bag also include a handle piece provided with a zipper for joining to the main body. Each of the side gusset panels has a round shape, a substantially square shape, an oblong shape, or a trapezoidal shape, for forming a duffel/gym bag, an overnight/weekender bag, a briefcase/portfolio, or a tote bag, respectively.

A SIXTH EXAMPLE, U.S. Patent Office Document No. 20120273100, Published on Nov. 1, 2012, to Appleton teaches a tote bag including a selectively openable and closable bag opening, a plurality of compartments—each having an interior storage area, a first exterior bag surface and a second exterior bag surface. The first or the second exterior surface of each of the plurality of compartments is selectively displayable by turning the tote bag inside out. Further includes are apparatus for selectively opening and closing the tote bag opening, and at least one apparatus for toting the tote bag. The plurality of compartments are attached to each other along a single line so that each compartment is movable independently.

A SEVENTH EXAMPLE, U.S. Patent Office Document No. 20130098922, Published on Apr. 25, 2013, to Chen, et al. teaches a portable slow cooker capable of engaging a lid and a liner container to prevent the soup from spilling out. The structure includes a cooking body, a liner container, a lid, and a handle. The liner container is disposed within the cooking body, and the lid is disposed on the opening of the liner container. The handle is spanned over the lid, and has lower ends in vertically slidable cooperation with handle boxes disposed at a side surface of the cooking body. The handle is locked by the handle boxes when slid to an lowest position so as to press the lid to form a sealing engagement with the liner container. As long as the handle is pushed to the lowest position, being locked, the lid and the liner of the container is engageable to prevent the soup from spilling out.

It is apparent now that numerous innovations for container holders have been provided in the prior art that adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a Tote for slow cookers and the like that avoids the disadvantages of the prior art.

ANOTHER OBJECT of the present invention is to provide a tote for slow cookers and the like that is simple and inexpensive to manufacture.

STILL ANOTHER OBJECT of the present invention is to provide a tote for slow cookers and the like that is simple to use.

BRIEFLY STATED, STILL YET ANOTHER OBJECT of the present invention is to provide a tote that is carried by a user and self-accommodates any container selected from different sized containers. The tote includes a bottom, a pair of side walls, and a pair of straps. The pair of side walls extend upwardly from the bottom, and are so disposed so as to allow the tote to self-accommodate the any container selected from the different sized containers. The pair of straps extend upwardly from the pair of side walls, respectively, and allow the tote to be carried by the user.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic perspective view illustrating a tote for slow cookers being utilized to carry a crock pot;

FIG. 2 is a diagrammatic perspective view illustrating a tote for slow cookers with a slow cookers shown in phantom lines installed therein;

FIG. 3 is an exploded view showing the pattern of the parts which are utilized to assemble the pot holding portion of the tote;

FIG. 4 is an exploded view showing the pattern of the parts which are utilized to assemble the sling/strap portion of the tote;

FIG. 5 is a left side elevational view taken in the direction of arrow 5 in FIG. 2;

FIG. 6 is a top plan view taken in the direction of arrow 6 in FIG. 2;

FIG. 7 is a front elevational view taken in the direction of arrow 7 in FIG. 2;

FIG. 8 is a bottom plan view taken in the direction of arrow 8 in FIG. 2;

FIG. 9 is an enlarged cross sectional view, with parts broken away, taken along line 9-9 in FIG. 6; and

FIG. 10 is an enlarged cross sectional view, with the sling/strap omitted, and with parts broken away, taken along line 10-10 in FIG. 6.

### A MARSHALING OF REFERENCE NUMERALS UTILIZED IN THE DRAWING

10 tote of embodiments of present invention for being carried by user 12 and for self-accommodating any container 14 selected from different sized containers

12 user

14 any container selected from different sized containers

16 bottom

18 pair of side walls

20 pair of straps for allowing tote 10 to be carried by user 12

22 oval-shaped bottom of bottom 16

24 pair of long edges of oval-shaped bottom 22 of bottom 16

26 pair of short edges of oval-shaped bottom 22 of bottom 16

27 trapezoid-shaped side wall of each side wall of pair of side walls 18

28 pair of side edges of trapezoid-shaped side wall 27 of each side wall of pair of side walls 18

30 quilted insulating material of trapezoid-shaped side wall 27 of each side wall of pair of side walls 18

32 indicia material of trapezoid-shaped side wall 27 of each side wall of pair of side walls 18

34 quilted insulating material of oval-shaped bottom 22 of bottom 16

36 indicia material of oval-shaped bottom 22 of bottom 16

38 pocket of trapezoid-shaped side wall 27 of one side wall of pair of side walls 18

40 spaces for allowing tote 10 to self-accommodate any container 14 selected from different sized containers by having any container 14 selected from different sized containers extend therethrough as needed

42 pair of reinforcement patches of each side wall of pair of side walls

44 linear reinforcement of oval-shaped bottom 22 of bottom 16

46 U-shaped cross sections 46 of linear reinforcement 44 of oval-shaped bottom 22 of bottom 16

48 U-shaped cross sections of pair of straps 20, respectively

### DETAILED DESCRIPTION OF THE PREFERRED EMBODIMENT

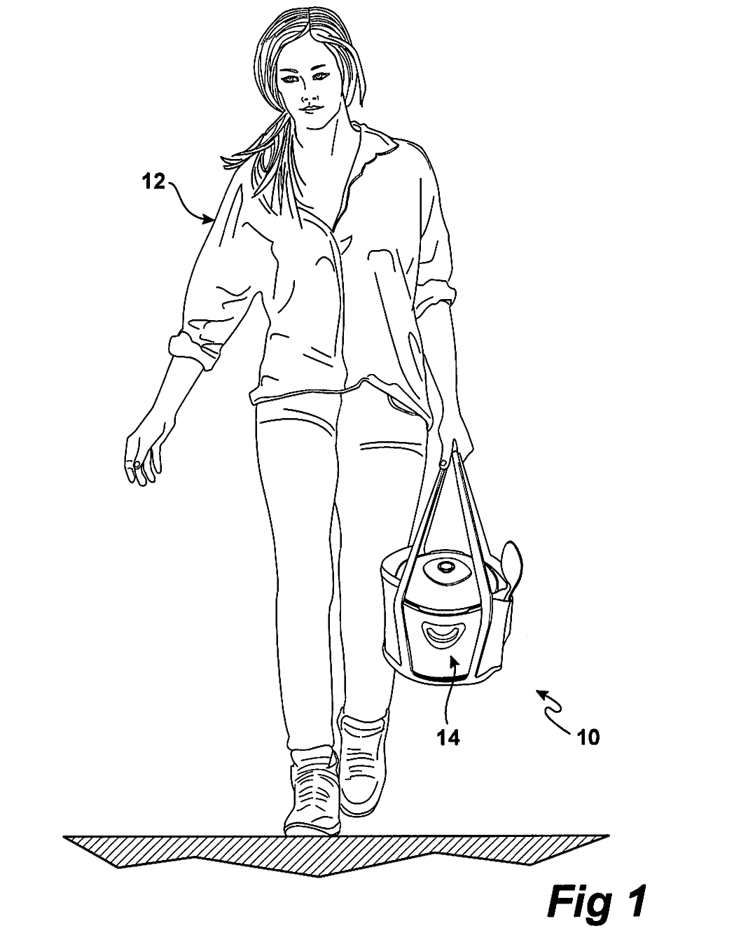

Referring now to the figures, in which like numerals indicate like parts, and particularly to FIG. 1, the tote of the embodiments of the present invention is shown generally at 10 for being carried by a user 12 and for self-accommodating any container 14 selected from different sized containers.

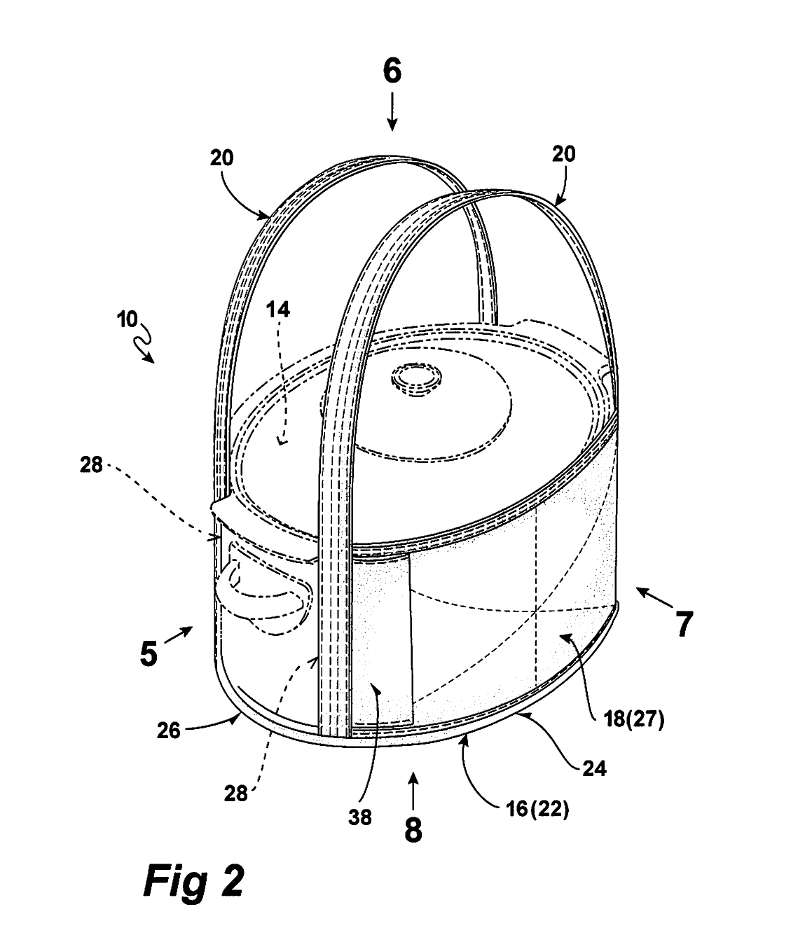

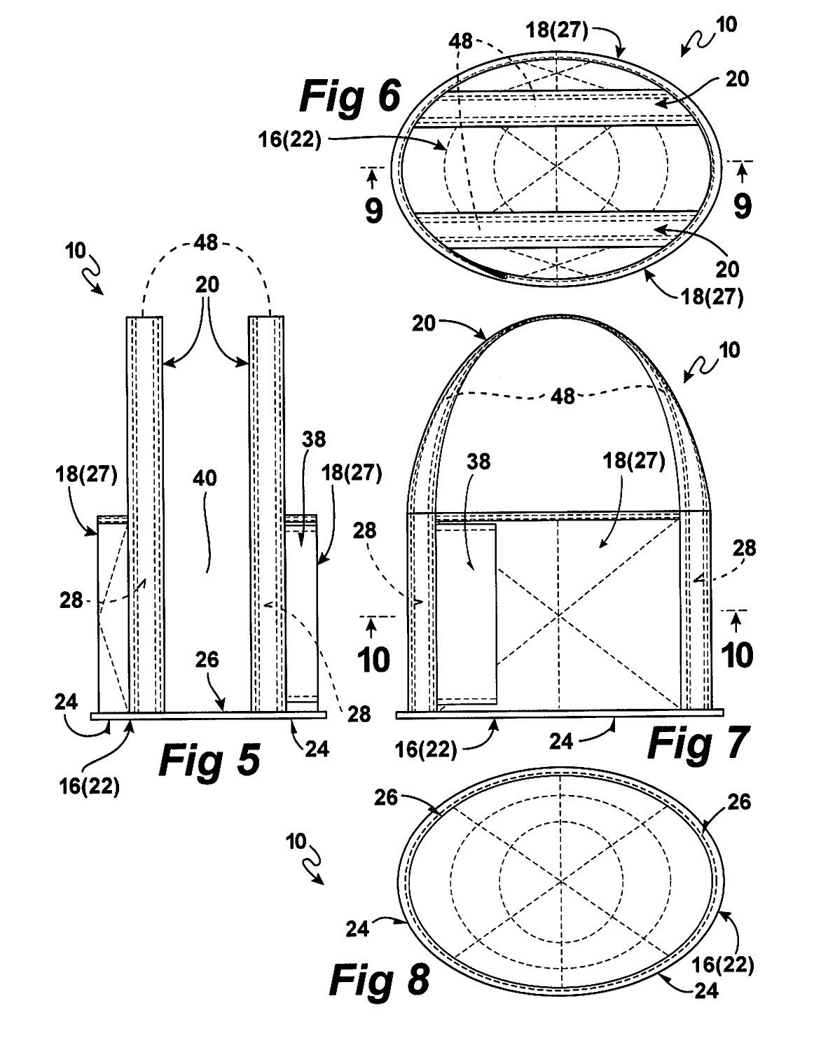

The overall configuration of the tote 20 can best be seen in FIGS. 2, 5, 6, 7, and 8, and as such, will be discussed with reference thereto.

The tote 10 comprises a bottom 16, a pair of side walls 18, and a pair of straps 20. The pair of side walls 18 extend upwardly from the bottom 16, and are so disposed so as to allow the tote 10 to self-accommodate the any container 14 selected from the different sized containers. The pair of straps 20 extend upwardly from the pair of side walls 18, respectively, and are for allowing the tote 10 to be carried by the user 12.

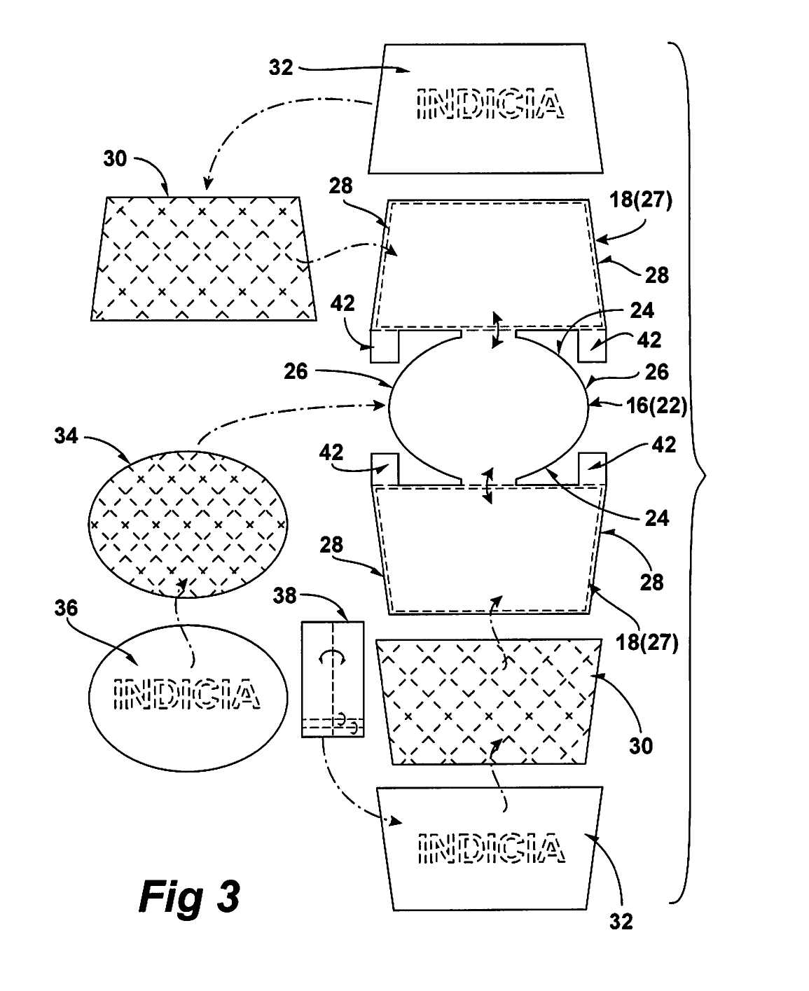

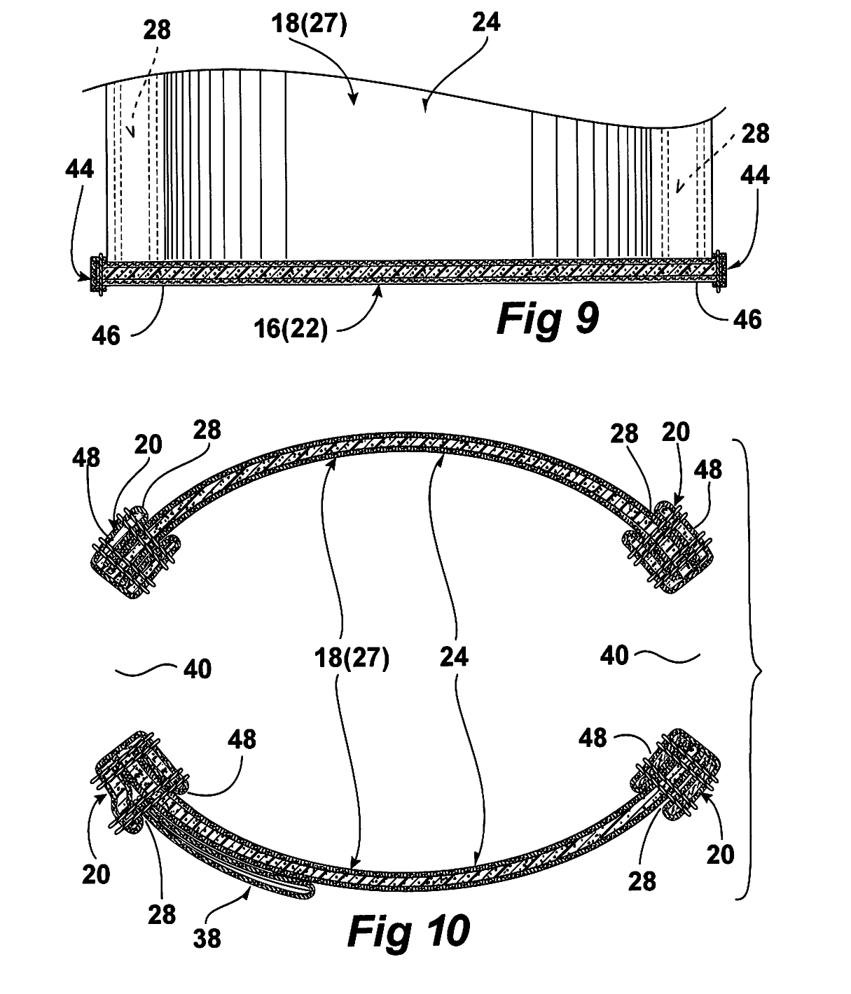

The specific configuration of the bottom 16 and the pair of side walls 18 can best be seen in FIGS. 2, 3, 4, 5, 6, 7, 8, 9, and 10, and as such, will be discussed with reference thereto.

The bottom 16 is an oval-shaped bottom 22.

The oval-shaped bottom 22 of the bottom 16 has, by definition, a pair of long edges 24 and a pair of short edges 26.

The pair of side walls 18 extend upwardly from only the pair of long edges 24 of the oval-shaped bottom 22 of the bottom 16, respectively.

Each side wall 18 is a trapezoid-shaped side wall 27.

The trapezoid-shaped side wall 27 of each side wall 18 has a pair of side edges 28.

The trapezoid-shaped side wall 27 of each side wall 18 can have a quilted insulating material 30.

The trapezoid-shaped side wall 27 of each side wall 18 can have an indica material 32.

The oval-shaped bottom 22 of the bottom 16 can have a quilted insulating material 34.

The oval-shaped bottom 22 of the bottom 16 can have an indicia material 36.

The tote 20 can have any combination of the quilted insulating material 30 of the trapezoid-shaped side wall 27 of each side wall 18, the indica material 32 of the trapezoid-shaped side wall 27 of each side wall 18, the quilted insulating material 34 of the oval-shaped bottom 22 of the bottom 16, and the indicia material 36 of the oval-shaped bottom 22 of the bottom 16.

The trapezoid-shaped side wall 27 of one side wall 18 further has a pocket 38.

The pocket 38 of the trapezoid-shaped side wall 27 of the one side wall 18 is disposed directly adjacent to, and has a height of, one side edge 28 of the trapezoid-shaped side wall 27 of the one side wall 18 so as to contain items that will not interfere with the pair of straps 20 when the user 12 is carrying the tote 10.

Since the pair of side walls 18 extend upwardly from only the pair of long edges 24 of the oval-shaped bottom 22 of the bottom 16, respectively, there are spaces 40 left open between the pair of side walls 18, with the spaces 40 allowing the tote 10 to self-accommodate the any container 14 selected from the different sized containers by having the any container 14 selected from the different sized containers extend through the spaces 40 as needed.

Each side wall 18 further has a pair of reinforcement patches 42.

The pair of reinforcement patches 42 of each side wall 18 depend therefrom, and are adjacent to the pair of side edges 28 of an associated side wall 18, respectively, so when the pair of side walls 18 extend upwardly from only the pair of long edges 24 of the oval-shaped bottom 22 of the bottom 16, respectively, the pair of reinforcement patches 42 of each side wall 18 are affixed to the oval-shaped bottom 22 of the bottom 16.

The oval-shaped bottom 22 of the bottom 16 further has linear a reinforcement 44.

The linear reinforcements 44 of the oval-shaped bottom 22 of the bottom 16 are slender, elongated, and folded upon itself to form U-shaped cross sections 46.

The linear reinforcement 44 of the oval-shaped bottom 22 of the bottom 16 extend only along, and whose U-shaped cross sections 46 capture, the entire edge of the oval-shaped bottom 22 of the bottom 16.

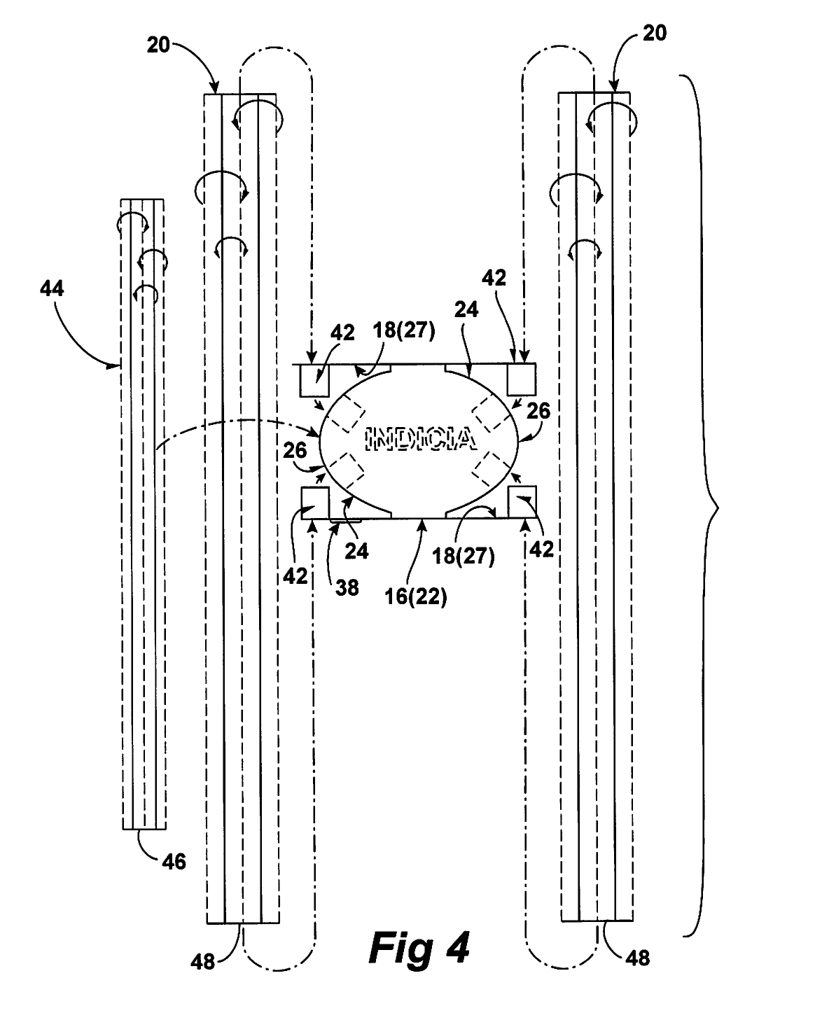

The specific configuration of then pair of straps 20 can best be seen in FIGS. 4, 5, 6, 7, and 10, and as such, will be discussed with reference thereto.

The pair of straps 20 are slender, elongated, and folded upon themselves to form U-shaped cross sections 48, respectively.

The pair of straps 20 extend upwardly along and past, and whose U-shaped cross sections 48 capture, the pair of side edges 28 of the trapezoid-shaped side wall 27 of the pair of side walls 18, respectively.

It will be understood that each of the elements described above, or two or more together, may also find a useful application in other types of constructions differing from the types described above.

While the invention has been illustrated and described as embodiments of a tote for slow cookers and the like, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A tote for being carried by a user and for self-accommodating any container selected from different sized containers, comprising:
a) a bottom;
b) a pair of side walls; and
c) a pair of straps;
wherein said pair of side walls extend upwardly from said bottom;
wherein said pair of side walls are so disposed so as to allow said tote to self-accommodate the any container selected from the different sized containers;
wherein said pair of straps extend upwardly from said pair of side walls, respectively; and
wherein said pair of straps are for allowing said tote to be carried by the user.

2. The tote of claim 1, wherein said bottom is an oval-shaped bottom.

3. The tote of claim 2, wherein said oval-shaped bottom of said bottom, has, by definition:
a) a pair of long edges; and
b) a pair of short edges.

4. The tote of claim 3, wherein said pair of side walls extend upwardly from only said pair of long edges of said oval-shaped bottom of said bottom, respectively.

5. The tote of claim 3, wherein each side wall is a trapezoid-shaped side wall.

6. The tote of claim 5, wherein said trapezoid-shaped side wall of each side wall has a pair of side edges.

7. The tote of claim 5, wherein said trapezoid-shaped side wall of each side wall has a quilted insulating material.

8. The tote of claim 5, wherein said trapezoid-shaped side wall of each side wall has an indicia material.

9. The tote of claim 2, wherein said oval-shaped bottom of said bottom has a quilted material.

10. The tote of claim 2, wherein said oval-shaped bottom of said bottom has an indicia material.

11. The tote of claim 5, wherein at least one of said trapezoid-shaped side wall of each side wall and said oval-shaped bottom of said bottom has at least one of a quilted insulating material and an indica material.

12. The tote of claim 6, wherein said trapezoid-shaped side wall of one side wall has a pocket.

13. The tote of claim 12, wherein said pocket of said trapezoid-shaped side wall of said one side wall is disposed directly adjacent to, and has a height of, one side edge of said trapezoid-shaped side wall of said one side wall so as to contain items that will not interfere with said pair of straps when the user is carrying said tote.

14. The tote of claim 6, wherein since said pair of side walls extend upwardly from only said pair of long edges of said oval-shaped bottom of said bottom, respectively, there are spaces left open between said pair of side walls, with said spaces allowing said tote to self-accommodate the any container selected from the different sized containers by having the any container selected from the different sized containers extend through said spaces as needed.

15. The tote of claim 6, wherein each side wall has a pair of reinforcement patches.

16. The tote of claim 15, wherein said pair of reinforcement patches of each side wall depend therefrom.

17. The tote of claim 15, wherein said pair of reinforcement patches of each side wall are adjacent to said pair of side edges of said trapezoid-shaped side wall of an associated side wall so when said pair of side walls extend upwardly from only said pair of long edges of said oval-shaped bottom of said bottom, respectively, said pair of reinforcement patches of each side wall are affixed to said oval-shaped bottom of said bottom.

18. The tote of claim 3, wherein said oval-shaped bottom of said bottom has a linear reinforcement.

19. The tote of claim 18, wherein said linear reinforcement of said oval-shaped bottom of said bottom is slender.

20. The tote of claim 18, wherein said linear reinforcement of said oval-shaped bottom of said bottom is elongated.

21. The tote of claim 18, wherein said linear reinforcement of said oval-shaped bottom of said bottom is folded upon itself to form U-shaped cross sections, respectively.

22. The tote of claim 18, wherein said linear reinforcement of said oval-shaped bottom of said bottom extend along entire edge oval-shaped bottom.

23. The tote of claim 18, wherein said U-shaped cross sections of said linear reinforcement of said oval-shaped bottom of said bottom capture said pair of short edges of said oval-shaped bottom of said bottom.

24. The tote of claim 1, wherein said pair of straps are slender.

25. The tote of claim 1, wherein said pair of straps are elongated.

26. The tote of claim 1, wherein said pair of straps are folded upon themselves to form U-shaped cross sections, respectively.

27. The tote of claim 6, wherein said pair of straps extend upwardly along said pair of side edges of said trapezoid-shaped side wall of said pair of side walls, respectively.

28. The tote of claim 6, wherein said pair of straps extend upwardly past said pair of side edges of said trapezoid-shaped side wall of said pair of side walls, respectively.

29. The tote of claim 6, wherein said U-shaped cross sections of said pair of straps capture said pair of side edges of said trapezoid-shaped side wall of said pair of side walls, respectively.
